(19) United States
(12) Patent Application Publication
(10) Pub. No.: US 2026/0058571 A1
(43) Pub. Date: Feb. 26, 2026

(54) THREE-LEVEL INVERTER AND STORAGE MEDIUM

(71) Applicant: DENSO CORPORATION, Kariya-city (JP)

(72) Inventor: Masahiro KUSUMOTO, Kariya-city (JP)

(73) Assignee: DENSO CORPORATION, Kariya-city (JP)

(21) Appl. No.: 19/249,174

(22) Filed: Jun. 25, 2025

Related U.S. Application Data
(63) Continuation of application No. PCT/JP2023/042759, filed on Nov. 29, 2023.

(30) Foreign Application Priority Data
Dec. 27, 2022 (JP) 2022-210644

(51) Int. Cl. H02M 7/483; H02M 1/00; H02M 7/539

(52) U.S. Cl. CPC H02M 7/483; H02M 1/0009; H02M 7/539

(57) ABSTRACT

In a three-level inverter, the impedance of each of a plurality of upper arm paths is configured to be at a similar level, each of the plurality of upper arm paths being provided by a respective upper arm diode and providing an electrical path that connect a connection point of the high potential conductive member and the positive bus to the first end of the middle switch via the respective upper arm diode and the intermediate conductive member, and the impedance of each of the plurality of lower arm paths is configured to be at a similar level, each of the plurality of lower arm paths being provided by a respective lower arm diode and providing an electrical paths that connect a connection point of the low potential conductive member and the negative bus to the middle switch via the lower arm diode and the intermediate conductive member.

### CROSS-REFERENCE TO RELATED APPLICATIONS

The present application is a continuation application of International Application No. PCT/JP2023/042759 filed on Nov. 29, 2023, which claims priority to Japanese Application No. 2022-210644, filed on Dec. 27, 2022. The contents of these applications are incorporated herein by reference in their entirety.

### BACKGROUND

### 1. Technical Field

This disclosure relates to a three-level inverter and a storage medium.

### 2. Related Art

Conventionally, an inverter with two semiconductor switches (specifically, IGBTs) connected in parallel with each other is known, as described in JP200415910A1. This inverter includes a gate drive circuit that drives the two semiconductor switches, a comparator, an AND circuit, and a transformer. When the two semiconductor switches are driven by the gate drive circuit, the comparator detects the differential value of the collector current flowing in the switch with the higher temperature of the two semiconductor switches, and the primary winding of the transformer is driven via the AND circuit. As a result, an induced voltage is generated in the secondary winding, which is connected between the gates of the two semiconductor switches and constitutes the transformer, and the gate voltage of the semiconductor switch with the higher temperature rises. As a result, imbalance of the collector currents flowing in the two semiconductor switches is suppressed.

### SUMMARY

According to one aspect of this disclosure, a three-level inverter includes for each phase: a plurality of series-connected elements connected in parallel with each other. Each of the series-connected elements includes: an upper arm switch and a lower arm switch connected in series, an upper arm diode connected in reverse parallel to the upper arm switch, and a lower arm diode connected in reverse parallel to the lower arm switch. The three-level inverter further includes: a middle switch, a high potential conductive member that electrically connects the high potential terminal of each of the upper arm switches provided by the plurality of series-connected elements and a positive bus, a low potential conductive member that electrically connects the low-potential terminal of each of the lower arm switches provided by the plurality of series-connected elements and a negative bus, and an intermediate conductive member that electrically connects the low potential terminal of each of the upper arm switches provided by the plurality of series-connected elements, the high potential terminal of each of the lower arm switches provided by the plurality of series-connected elements, and the first end of the middle switch. The impedance of each of a plurality of upper arm paths is configured to be at a similar level, each of the plurality of upper arm paths being provided by a respective upper arm diode and providing an electrical path that connect a connection point of the high potential conductive member and the positive bus to the first end of the middle switch via the respective upper arm diode and the intermediate conductive member, and the impedance of each of a plurality of lower arm paths is configured to be at a similar level, each of the plurality of lower arm paths being provided by a respective lower arm diode and providing an electrical paths that connect a connection point of the low potential conductive member and the negative bus to the middle switch via the lower arm diode and the intermediate conductive member.

According to this disclosure, because the impedance of each upper arm path is configured to be at a similar level, and the impedance of each lower arm path is configured to be at a similar level, it is possible to suppress an imbalance of recovery currents.

### BRIEF DESCRIPTION OF THE DRAWING

The above and other objects, features and advantages of the present disclosure will become clearer with the following detailed description with reference to the accompanying drawings. The drawings are,

FIG. 1 shows an overall configuration of a control system according to a first embodiment,

FIG. 2 shows electrical connections of a U-phase circuit;

FIG. 3 is a diagram of each module;

FIG. 4 shows a plan view of each module;

FIG. 5 shows switching modes;

FIG. 6 shows an imbalanced state of recovery currents;

FIG. 7 shows an imbalanced state of recovery currents;

FIG. 8 is a timing chart showing an example of gate voltage UUs;

FIG. 9 shows a current distribution pattern in an oscillation suppression control;

FIG. 10 shows a current distribution pattern in the oscillation suppression control;

FIG. 11 shows a current distribution pattern in the oscillation suppression control;

FIG. 12 shows a current distribution pattern in the oscillation suppression control;

FIG. 13 shows a current distribution pattern in the oscillation suppression control;

FIG. 14 shows a current distribution pattern in the oscillation suppression control;

FIG. 15 shows a current distribution pattern in the oscillation suppression control;

FIG. 16 is a timing chart showing a switching control of the inverter for a comparative example;

FIG. 17 shows a current distribution pattern for a comparative example;

FIG. 18 shows a current distribution pattern for a comparative example;

FIG. 19 shows a current distribution pattern for a comparative example;

FIG. 20 shows a current distribution pattern for a comparative example;

FIG. 21 is a flowchart of an oscillation suppression control;

FIG. 22 is a flowchart of an oscillation suppression control according to a second embodiment;

FIG. 23 shows electrical connections of the U-phase circuit according to a third embodiment;

FIG. 24 is a flowchart of an oscillation suppression control according to the third embodiment.

### DETAILED DESCRIPTION OF THE PREFERRED EMBODIMENTS

A three-level inverter is known as well as the above-mentioned inverter. The three-level inverter includes for each phase, a plurality of a series-connected element of an upper arm switch and a lower arm switch, the plurality of the series-connected element being connected in parallel. The three-level inverter includes upper arm diodes, each of them are connected in reverse parallel to each upper arm switch, lower arm diodes, each of them are connected in reverse parallel to each lower arm switch, and a middle switch for each phase.

In each phase and each arm of the three-level inverter, an imbalance of the recovery current flowing through each diode can occur. Therefore, it is desirable to have a configuration that can suppress imbalance of the recovery currents.

This disclosure aims to provide a three-level inverter and a storage medium that can suppress an imbalance of recovery currents.

According to one aspect of this disclosure, a three-level inverter includes for each phase: a plurality of series-connected elements connected in parallel with each other. Each of the series-connected elements includes: an upper arm switch and a lower arm switch connected in series, an upper arm diode connected in reverse parallel to the upper arm switch, and a lower arm diode connected in reverse parallel to the lower arm switch. The three-level inverter further includes: a middle switch, a high potential conductive member that electrically connects the high potential terminal of each of the upper arm switches provided by the plurality of series-connected elements and a positive bus, a low potential conductive member that electrically connects the low-potential terminal of each of the lower arm switches provided by the plurality of series-connected elements and a negative bus, and an intermediate conductive member that electrically connects the low potential terminal of each of the upper arm switches provided by the plurality of series-connected elements, the high potential terminal of each of the lower arm switches provided by the plurality of series-connected elements, and the first end of the middle switch. The impedance of each of a plurality of upper arm paths is configured to be at a similar level, each of the plurality of upper arm paths being provided by a respective upper arm diode and providing an electrical path that connect a connection point of the high potential conductive member and the positive bus to the first end of the middle switch via the respective upper arm diode and the intermediate conductive member, and the impedance of each of a plurality of lower arm paths is configured to be at a similar level, each of the plurality of lower arm paths being provided by a respective lower arm diode and providing an electrical paths that connect a connection point of the low potential conductive member and the negative bus to the middle switch via the lower arm diode and the intermediate conductive member.

According to this disclosure, because the impedance of each upper arm path is configured to be at a similar level, and the impedance of each lower arm path is configured to be at a similar level, it is possible to suppress an imbalance of recovery currents.

The multiple embodiments are described below with reference to the drawings. In the plurality of embodiments, functionally and/or structurally corresponding and/or associated portions may be marked with the same reference code, or with reference codes differing by one hundred or more places. For corresponding and/or associated portions, reference may be made to the description of other embodiments.

### First Embodiment

A first embodiment of a three-level inverter of the present disclosure is described below with reference to the drawings. In this embodiment, the control system equipped with the three-level inverter is installed in an electric vehicle such as an electric vehicle or a hybrid vehicle.

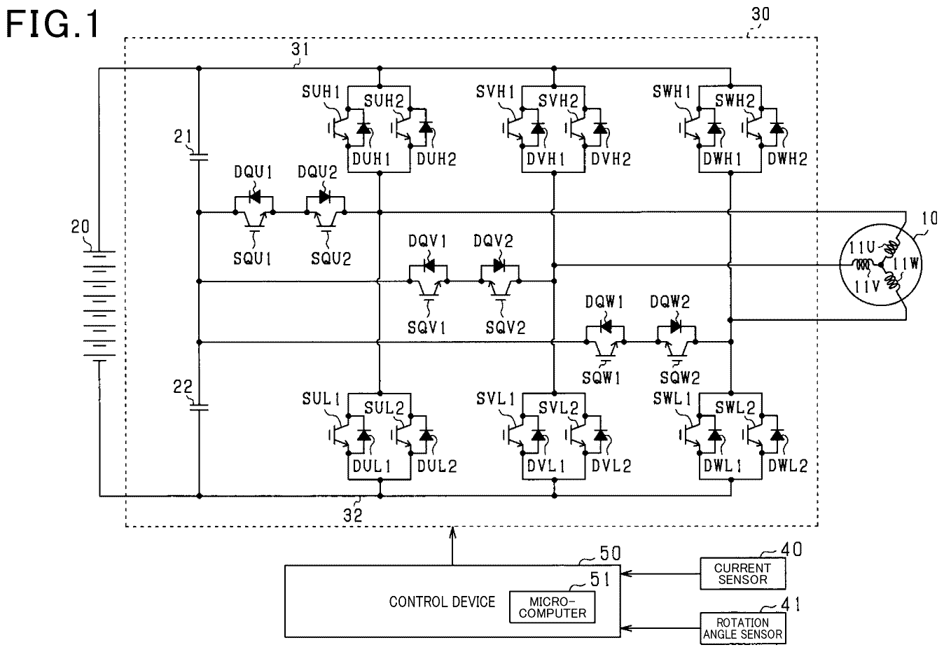

As shown in FIG. 1, the control system includes a motor 10, a battery 20 which is a DC power source, and an inverter 30. The motor 10 is the vehicle's main machine and includes a rotor, not shown. The rotor and the drive wheels of the vehicle can transmit power to each other. Motor 10 is a three-phase synchronous machine. Motor 10 includes a U-phase winding 11U, a V-phase winding 11V, and a W-phase winding 11W, star wired as stator winding. The winding 11U, the winding 11V, and the winding 11W of each phase are arranged with an offset of 120°therebetween in electrical angle. The motor 10 is, for example, a permanent magnet synchronous machine.

The battery 20 is electrically connected to the winding 11U, the winding 11V, and the winding 11W for each phase of the motor 10 via the inverter 30. The battery 20 is, for example, a battery assembly with series-connected elements of battery cells. The battery 20 is a chargeable and dischargeable secondary battery, for example, a lithium-ion battery.

The inverter 30 converts DC power supplied from battery 20 to three-phase AC power by switching control and supplies the converted AC power to each of the winding 11U, the winding 11V, and the winding 11W. The inverter 30 is a three-level inverter. The inverter 30 includes a first capacitor 21 and a second capacitor 22. The first capacitor 21 and the second capacitor 22 are connected in series. The battery 20 is connected in parallel to the series-connected elements of the first capacitor 21 and the second capacitor 22. In this embodiment, the capacitance of the first capacitor 21 and the second capacitor 22 are substantially the same value.

The inverter 30 includes upper arm switches and lower arm switches for each of the three phases. In this embodiment, each arm switch consists of multiple semiconductor switching devices connected in parallel, specifically two semiconductor switching devices connected in parallel. The semiconductor switching devices in this embodiment are IGBTs.

A U-phase upper arm switch includes a U-phase first upper arm switch SUH1 and a U-phase second upper arm switch SUH2. A U-phase lower arm switch includes a U-phase first lower arm switch SUL1 and a U-phase second lower arm switch SUL2. The U-phase first upper arm switch SUH1 is connected to a U-phase first upper arm diode DUH1 in reverse parallel. The U-phase first lower arm switch SUL1 is connected in reverse parallel to a U-phase first lower arm diode DUL1. The U-phase second lower arm switch SUL2 is connected in reverse parallel to a U-phase second lower arm diode DUL2. The U-phase second lower arm switch SUL2 is connected in reverse parallel to a U-phase second lower arm diode DUL2. Each arm diode may be a freewheel diode.

A V-phase upper arm switch includes a V-phase first upper arm switch SVH1 and a V-phase second upper arm switch SVH2. A V-phase lower arm switch includes a V-phase first lower arm switch SVL1 and a V-phase second lower arm switch SVL2. The V-phase first upper arm switch SVH1 is connected to a V-phase first upper arm diode DVH1 in reverse parallel. The V-phase second upper arm switch SVH2 is connected to a V-phase second upper arm diode DVH2 in reverse parallel. The V-phase first lower arm switch SVL1 is connected to a V-phase first lower arm diode DVL1 in reverse parallel. The V-phase second lower arm switch SVL2 is connected to a V-phase second lower arm diode DVL2 in reverse parallel.

A W-phase upper arm switch includes a W-phase first upper arm switch SWH1 and a W-phase second upper arm switch SWH2. A W-phase lower arm switch includes a W-phase first lower arm switch SWL1 and a W-phase second lower arm switch SWL2. The W-phase first upper arm switch SWH1 is connected to a W-phase first upper arm diode DWH1 in reverse parallel. The W-phase second upper arm switch SWH2 is connected to a W-phase second upper arm diode DWH2 in reverse parallel. The W-phase first lower arm switch SWL1 is connected to a W-phase first lower arm diode DWL1 in reverse parallel. The W-phase second lower arm switch SWL2 is connected to a W-phase second lower arm diode DWL2 in reverse parallel.

The electrical connections of the inverter 30, the battery 20 and the motor 10 is described using U-phase as an example. A positive bus 31 is connected to the collector, which is the respective high potential terminal of the first upper arm switch SUH1 and the second upper arm switch SUH2. The positive bus 31 is connected to the positive terminal of the battery 20 and the first end of the first capacitor 21. The second end of the first capacitor 21 is connected to the first end of the second capacitor 22. A negative bus 32 is connected to the emitters, which are the low potential terminals of the first capacitor 20 and the second capacitor 21, respectively. The negative bus 32 is connected to the negative terminal of the battery 20 and the second end of the second capacitor 22. Each of the positive bus 31 and the negative bus 32 are formed of a conductive member such as a bus bar.

The first end of the U-phase winding 11U is connected to the emitters of each of the U-phase first upper arm switch SUH1 and the U-phase second upper arm switch SUH2 and the collectors of each of the U-phase first lower arm switch SUL1 and the U-phase second lower arm switch SUL2. The second ends of each of the winding 11U, the winding 11V, and the winding 11W are connected to each other. The connection point is a neutral point.

The inverter 30 includes middle switches for three phases. Each of the three middle switches can conduct and interrupt current in both directions. In this embodiment, each middle switch consists of two semiconductor switching devices. Each of the two semiconductor switching devices may be IGBTs.

The middle switch of U-phase includes a U-phase first switch SQU1 and a second switch SQU2. The U-phase first switch SQU1 is connected to a U-phase first diode DQU1 in reverse parallel. The U-phase second switch SQU2 is connected to a U-phase second diode DQU2 in reverse parallel. The middle switch of V-phase includes a V-phase first switch SQV1 and a V-phase second switch SQV2. The V-phase first switch SQV1 is connected to a V-phase first diode DQV1 in reverse parallel. The V-phase second switch SQV2 is connected to a V-phase second diode DQV2 in reverse parallel. The W-phase middle switch includes a W-phase first switch SQW1 and a second switch SQW2. The W-phase first switch SQW1 is connected to a W-phase first diode DQW1 in reverse parallel.

The W-phase second switch SQW2 is connected to a W-phase second diodes DQW2. Each diode may be a freewheeling diode.

The electrical connection of the middle switch is described using U-phase as an example. The emitter of the U-phase first switch SQU1 is connected to the emitter of U-phase second switch SQU2. The collector of the U-phase first switch SQU1 is connected to the second end of the first capacitor 21 and the second end of the second capacitor 22. The emitter of the U-phase second switch SQU2 is connected to the emitter of the U-phase first upper arm switch SUH1, the emitter of the U-phase second upper arm switch SUH2, the collector of U-phase first lower arm switch SUL1, and the collector of the U-phase second lower arm switch SUL2.

The control system includes a current sensor 40 and a rotation angle sensor 41. The current sensor 40 detects the phase currents flowing in the winding 11U, the winding 11V, and the winding 11W. The rotation angle sensor 41 detects the rotation angle (specifically, the electric angle) of the motor 10. The rotation angle sensor 41 may be a resolver. Each of the detected values of the current sensor 40 and the rotation angle sensor 41 are input to the control device 50 provided by the control system.

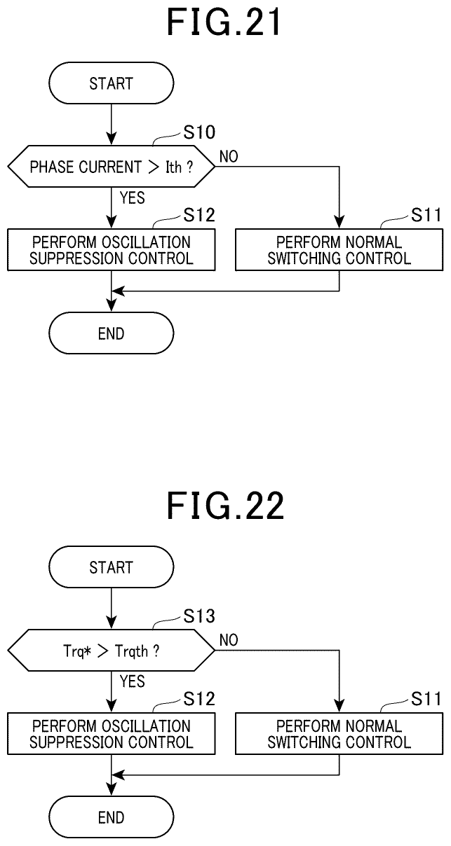

The control device 50 is mainly composed of a microcontroller 51. The microcontroller 51 includes a CPU. The functions provided by microcontroller 51 can be provided by software recorded in a substantive memory device and a computer executing it, software only, hardware only, or a combination thereof. For example, if microcontroller 51 is provided by an electronic circuit that is hardware, it can be provided by a digital or analog circuit that contains some logic circuits. For example, the microcontroller 51 executes a program stored in a non-transitory tangible storage medium as its own storage unit. The program includes, for example, a program for the process shown in FIG. 21, etc. below. When the program installed in control device 50 is executed, the method corresponding to the program is performed. The memory is, for example, a nonvolatile memory. The program stored in the memory section can be downloaded and updated via a communication network such as the Internet, for example, by a method known as OTA (Over the Air).

The control device 50 generates drive signals for each switch SUH1 to SWL2 and SQU1 to SQW2 of the inverter 30 to make the control amount of the motor 10 approach the command value. The drive signals include ON command and OFF command. The control device 50 turns on and off each switch SUH1 to SWL2 and SQU1 to SQW2 based on the generated drive signals. In this system, the control quantity is torque, and the command value is the command torque Trq*.

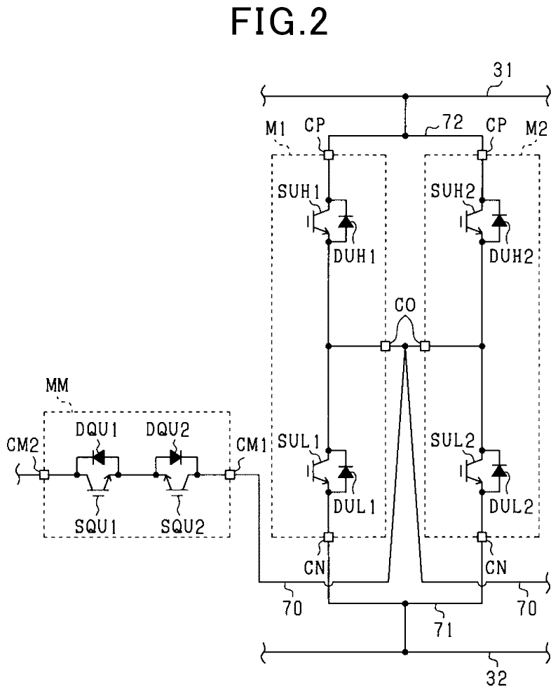

In this embodiment, the inverter 30 is composed of switch modules. It is described using U-phase as an example, referring to FIGS. 2 through 4 below.

The circuit that composes U-phase of the inverter 30 consists of three switch modules. For example, switch modules include a first module M1 and a second module M2 (corresponding to “arm module”) and an intermediate module MM. Each switch module M1, M2, and MM has a casing 60. Each of the casing 60 stores semiconductor switching elements and freewheeling diodes. The shape of each 60 is flat rectangular. In this embodiment, the shape of the casing 60 of each module M1, M2, MM is substantially identical.

The casing 60 of the first module M1 stores the U-phase upper arm switch SUH1, the U-phase upper arm diodeUH1, the U-phase lower arm switch SUL1, and the U-phase lower arm diode DUL1. The collector of the U-phase upper arm switch SUH1 is connected to the high potential external terminal CP provided on the casing 60 of the first module M1. The emitter of the U-phase first lower arm switch SUL1 is connected to the low potential external terminal CN provided on the casing 60 of the first module M1. The emitter of the U-phase first upper arm switch SUH1 and the collector of the U-phase first lower arm switch SUL1 are connected to the intermediate external terminal CO provided on the casing 60 of the first module M1.

The casing 60 of the second module M2 stores the U-phase second upper arm switch SUH2, the U-phase second upper arm diodeUH2, the U-phase second lower arm switch SUL2 and the U-phase second lower arm diode DUL2. Since the configuration of the second module M2 and the first module M1 are the same in this system, a detailed description of the second module M2 is omitted.

In this embodiment, the first module M1 and the second module M2 have the same specifications. Therefore, the internal configuration of the first module M1 and the second module M2 are identical. In detail, the specifications of each switch SUH1, SUL1, SUH2, and SUL2 stored in the first and second modules M1 and M2 are identical, and the specifications of each diode DUH1, DUL1, DUH2, and DUL2 are identical. Therefore, the design values of the threshold voltage Vth of each switch SUH1, SUL1, SUH2, and SUL2 are set to the same value, and the design values of the rated current of each switch SUH1, SUL1, SUH2, and SUL2 are set to the same value. The design value of the reverse recovery time of each diode DUH1, DUL1, DUH2, and DUL2 is set to the same value, and the design value of the on-resistance of each diode DUH1, DUL1, DUH2, and DUL2 is set to the same value.

The casing 60 of the intermediate module MM stores the U-phase first switch SQU1, the second switch SQU2, the U-phase first diode DQU1, and the U-phase second diode DQU2. The collector of the U-phase first switch SQU1 is connected to the neutral point terminal CM2 provided on the casing 60 of the intermediate module MM. The collector of the U-phase second switch SQU2 is connected to the intermediate terminal CM1 provided on the casing 60 of the intermediate module MM.

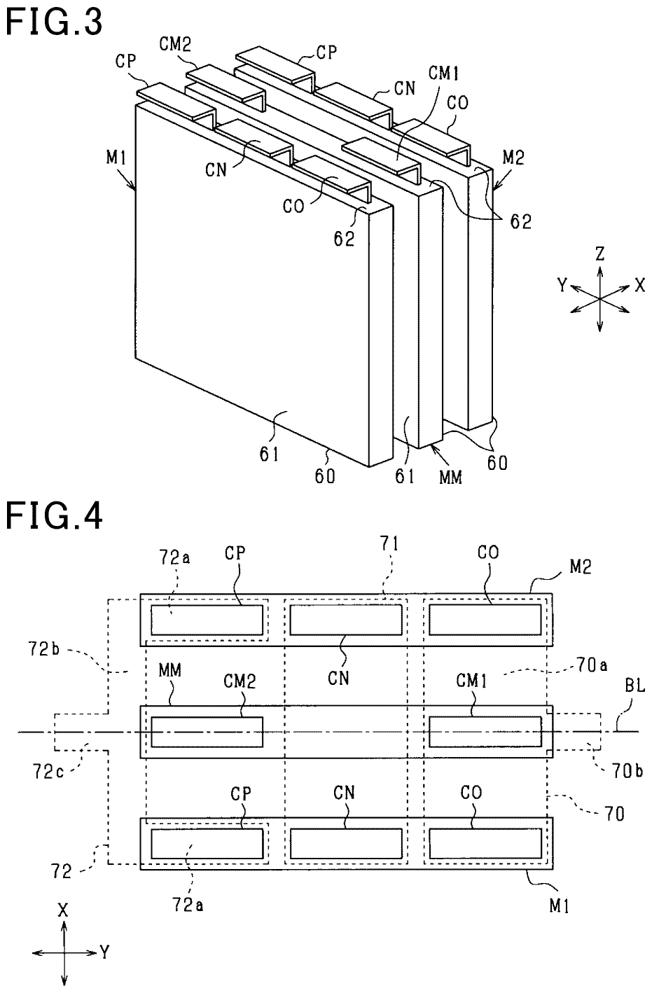

As shown in FIGS. 3 and 4, the casing 60 of each module M1, M2, and MM includes a pair of main plate sections 61 facing each other in the thick direction (X direction) and a terminal installation surface 62 connecting the ends of each main plate section 61. Each module M1, M2, and MM are arranged side-by-side in the thick direction of the casing 60 with the main plate sections 61 facing each other. The terminal installation surfaces 62 of each module M1, M2, and MM face a common specific direction (Z direction) orthogonal to the X direction. The intermediate module MM is sandwiched between the first module M1 and the second module M2.

In each of the first module M1 and the second module M2, the high potential external terminal CP, the low potential external terminal CN, and the intermediate external terminal CO are arranged in the Y direction on the terminal installation surface 62. The Y direction is orthogonal to the X direction and the Z direction. In intermediate module MM, the neutral point terminal CM2 and the intermediate terminal CM1 are arranged in the Y direction on the terminal installation surface 62. When each module M1, M2, and MM are lined up, the two high potential external terminals CP and the neutral point terminal CM2 are arranged in the X direction, the two intermediate external terminals CO and the intermediate terminal CM1 are arranged in the X direction, and the two low potential external terminals CN are arranged in the X direction.

As shown in FIGS. 2 and 4, the high potential external terminal CP of the first module M1 and the high potential external terminal CP of the second module M2 are connected by a high potential bus bar 72 (an example of “high potential conductive member”). As shown in FIG. 4, the high potential bus bar 72 is symmetrical with respect to the reference axis BL passing through the center of the thick direction of the casing 60 of intermediate module MM in front view of the terminal installation surface 62. The high potential bus bar 72 includes two terminal connections 72a, a first connection 72b and a second connection 72c. In the front view of the terminal installation surface 62, the first connection 72b extends in the X direction. The terminal connection 72a extends in the Y direction from both longitudinal ends of the first connection 72b. One of the two terminal connections 72a is connected to the high potential external terminal CP of the first module M1, and the other is connected to the high potential external terminal CP of the second module M2. The second connection 72c extends from the longitudinal center of the first connection 72b in the direction opposite to that in which the terminal connection 72a extends with respect to the first connection 72b. The second connection 72c is connected to the positive bus 31.

The high potential external terminals CP of the first and second modules M1 and M2 and the intermediate terminal CM1 of intermediate module MM are connected by an intermediate bus bar 70 (an example of “intermediate conductive member”). The intermediate bus bar 70 is symmetrical with respect to the reference axis BL in the front view of the terminal installation surface 62, as shown in FIG. 4. The intermediate bus bar 70 includes a first connection 70a and a second connection 70b. The first connection 70a extends in the X direction. The second connection 70b extends from the longitudinal center of the first connection 70a in the Y direction in the opposite direction to the high potential busbar 72. The second connection 70b is connected to the neutral point terminal CM2 of intermediate module MM and the first end of the windings of the motor 10.

The symmetrical structure of the high potential busbar 72, the first and second modules M1 and M2 having the same specifications, and the symmetrical structure of the intermediate busbar 70 make the impedances of the first and second upper arm paths at similar levels (in other word, equal or equivalent). The first upper arm path is an electrical path connecting the second connection 72c to the intermediate terminal CM1 of intermediate module MM via the first connection 72b, the high potential external terminal CP of the first module M1, the U-phase first upper arm diode DUH1, the intermediate external terminal CO of the first module M1, the first connection 70a and the second connection 70b. The first upper arm path is the electrical path corresponding to the U-phase first upper arm diode DUH1. The second upper arm path is an electrical path that connects the second connection 72c to the intermediate terminal CM1 of intermediate module MM via the first connection 72b, the high potential external terminal CP of the second module M2, the U-phase second upper arm diode DUH2, the intermediate external terminal CO of the second module M2, the first connection 70a and the second connection 70b. The second upper arm path is the electrical path corresponding to U-phase second upper arm diode DUH2. The “impedance of the first upper arm path and the second upper arm path are at similar levels” means, for example, that the value of impedance deviation between the first upper arm path and the second upper arm path is within the range of plus or minus 20% of the impedance of the greater one of the first upper arm path and the second upper arm path, or preferably, that the value of deviation above means within the range of plus or minus 15% of the impedance of the greater one of the first upper arm path and the second upper arm path, or more preferably, the value of the deviation above is within the range of plus or minus 5% of the impedance of the greater one of the first upper arm path and the second upper arm path.

The low-potential external terminal CN of the first module M1 and the low-potential external terminal CN of the second module M2 are connected by a low-potential bus bar 71 (an example of “low potential conductive member”). As shown in FIG. 4, the low-potential bus bar 71 is symmetrical with respect to the reference axis BL in the front view of the terminal installation surface 62 and extends in the X direction. The center portion of the low-potential bus bar 71 in the X direction is connected to negative bus 32.

The symmetrical structure of the low-potential bus bar 71, the fact that the first and second modules M1 and M2 have the same specifications, and the symmetrical structure of the intermediate bus bar 70 make the impedances of the first and second lower arm paths at similar levels (in other words, equal or equivalent). The first lower arm path is an electrical path connecting the center of the low-potential busbar 71 in the X direction to the intermediate terminal CM1 of the intermediate module MM via the low-potential external terminal CN of the module M1, the U-phase first lower arm diode DUL1, the intermediate external terminal CO of the module M1, the first connection 70a and the second connection 70b. The first lower arm path is the electrical path corresponding to the U-phase first lower arm diode DUL1. The second lower arm path is an electrical path that connects the center of the low-potential bus bar 71 in the X direction to the intermediate terminal CM1 of intermediate module MM via the low-potential external terminal CN of the module M2, the U-phase second lower arm diode DUL2, the intermediate external terminal CO of the module M2, the first connection 70a and the second connection 70b. The second lower arm path is the electrical path corresponding to the U-phase second lower arm diode DUL2. The “impedance of the first lower arm path and the second lower arm path is at a similar level “means, for example, that the value of impedance deviation between the first lower arm path and the second lower arm path is within the range of plus or minus 20% of the impedance of the greater one of the first lower arm path and the second lower arm path, or preferably, the value of the deviation above is within the range of plus or minus 15% of the impedance of the greater one of the first lower arm path and the second lower arm path, or more preferably, the value of the deviation above is within the range of plus or minus 5% of the impedance of the greater one of the first lower arm path and the second lower arm path.

In this embodiment, there are no external terminals between the intermediate terminal CM1 and the neutral point terminal CM2 on the terminal installation surface 62 of the intermediate module MM. This reduces the degree of crowding of the external terminals when the three modules M1, M2, and MM are assembled in each phase, thereby improving heat dissipation.

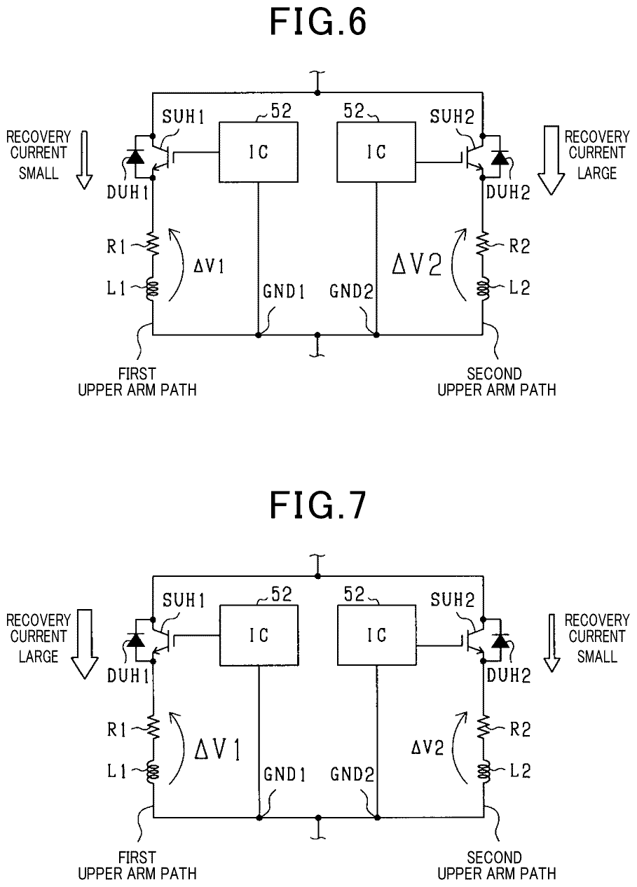

The control device 50 includes a drive circuit 52 (FIG. 6). The drive circuit 52, for example, corresponds to each switch SUH1-SWL2 provided by the inverter 30.

When the drive circuit 52 determines that the input drive signal is the ON command, it supplies a charging current to the gate of the switch corresponding to itself. As a result, the gate voltage of the switch becomes higher than the threshold voltage Vth, and the switch is turned on. On the other hand, when the drive circuit 52 determines that the drive signal is the OFF command, it causes a discharge current to flow from the gate of the switch corresponding to itself to the ground terminal. As a result, the gate voltage of the switch becomes less than the threshold voltage Vth, and the switch is turned off.

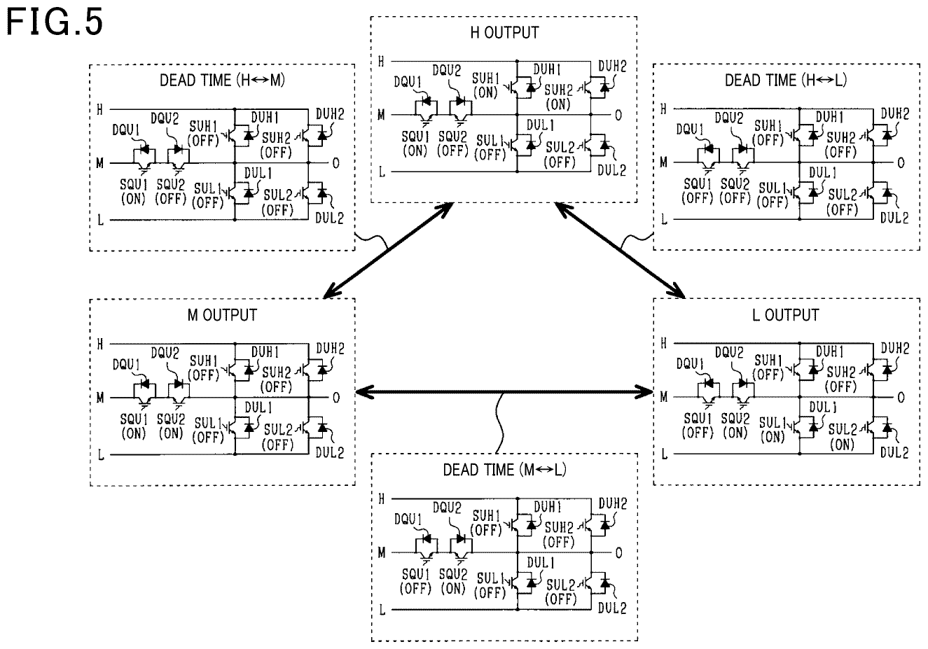

Referring to FIG. 5, the three levels of voltage that can be output from the inverter 30 are explained, using the U-phase as an example.

The inverter 30 can output three levels of voltage: H, M, and L. When the L level voltage is 0, the H level voltage is equivalent to the voltage between both ends of the series-connected elements of the first capacitor 21 and the second capacitor 22, and the M level voltage is equivalent to the voltage between both ends of the second capacitor 22.

When outputting the H level voltage, the control device 50 turns on the U-phase first upper arm switch SUH1 and the U-phase second upper arm switch SUH2, turns off the U-phase first lower arm switch SUL1 and the U-phase second lower arm switch SUL2, turns on the U-phase first switch SQU1 and turns off the U-phase second switch SQU2. The U-phase second switch SQU2 is turned off to prevent a short circuit between both ends of the first capacitor 21 via the U-phase first upper arm switch SUH1, the U-phase second upper arm switch SUH2, the U-phase second switch SQU2 and the U-phase first diode DQU1. Hereafter, the switching mode for outputting the H level voltage is sometimes referred to as H level mode.

When outputting the M level voltage, the control device 50 turns off the U-phase first upper arm switch SUH1, the U-phase second upper arm switch SUH2, the U-phase first lower arm switch SUL1, and the U-phase second lower arm switch SUL2, and turns on the U-phase first switch SQU1 and the second switch SQU2. Hereafter, the switching mode for outputting the M level voltage is sometimes referred to as M level mode.

When switching from the H level mode to the M level mode or from the M level mode to the H level mode, the control device 50 implements a H-M dead time mode during the switching. When performing the H-M dead time mode, the control device 50 turns off the U-phase second upper arm switch SUH2, the U-phase first lower arm switch SUL1, the U-phase second lower arm switch SUL2, and the U-phase second switch SQU2 and turns on the U-phase first switch SQU1.

When outputting the L level voltage, the control device 50 turns off the U-phase first upper arm switch SUH1 and the U-phase second upper arm switch SUH2, turns on the U-phase first lower arm switch SUL1 and the U-phase second lower arm switch SUL2, turns off the U-phase first switch SQU1, and turns on the U-phase second switch SQU2. The U-phase first switch SQU1 is turned off to prevent a short circuit at both ends of the second capacitor 22 via the U-phase first lower arm switch SUL1, the U-phase second lower arm switch SUL2, the U-phase second switch SQU2 and the U-phase first diode DQU1. Hereafter, the switching mode for outputting the L level voltage is sometimes referred to as the L level mode.

When switching from the M level mode to the L level mode or from the L level mode to the M level mode, the control device 50 implements a M-L dead time mode during the switching. When performing the M-L dead time mode, the control device 50 turns on the U-phase second upper arm switch SUH2, the U-phase first lower arm switch SUL1, the U-phase second lower arm switch SUL2 and the U-phase first switch SQU1 and turns off the U-phase second switch SQU2.

When switching from the H level mode to the L level mode or from the L level mode to the H level mode, the control device 50 implements a H-L dead time mode during the switching. When performing the H-L dead time mode, the control device 50 turns off the U-phase second upper arm switch SUH2, the U-phase first lower arm switch SUL1, the U-phase second lower arm switch SUL2, the U-phase first Switch SQU1, and the U-phase second Switch SQU2.

In each phase, an imbalance of the recovery currents flowing through the freewheel diodes of each switch connected in parallel can occur. When the imbalance occurs, the gate voltage of each switch may oscillate, and each switch may fail. It is described using the U-phase upper arm as an example referring to FIGS. 6 and 7. FIGS. 6 and 7 show the current distribution immediately after switching from the L level mode to the H level mode via the H-L dead time mode when current flows from the inverter 30 to the windings.

For example, the ground terminal GND1 of the drive circuit 52 electrically connected to the gate of the U-phase first upper arm switch SUH1, is connected to a portion between the emitter of the U-phase first upper arm switch SUH1 and the intermediate external terminal CO of the first module M1 in the first upper arm path. The U-phase second upper arm switch SUH2 electrically connected to the gate of the ground terminal GND2 of the drive circuit 52, is connected to a portion between the emitter of the U-phase second upper arm switch SUH2 and the intermediate external terminal CO of the second module M2 in the second upper arm path, for example.

In FIG. 6, R1 and L1 schematically show the resistance and the inductance components that exist between the emitter of the U-phase first upper arm switch SUH1 and the ground terminal GND1 in the first upper arm path. R2 and L2 schematically show the resistance and the inductance components that exist between the emitter of the U-phase second upper arm switch SUH2 and the ground terminal GND2 in the second upper arm path. ΔV1 is the voltage between the emitter of the U-phase first upper arm switch SUH1 and the ground terminal GND1 (hereinafter referred to as the first voltage) in the first upper arm path. ΔV2 is the voltage between the emitter of the U-phase second upper arm switch SUH2 and the ground terminal GND2 in the second upper arm path.

Due to variations in the threshold voltage Vth of the U-phase upper arm switch SUH1 and the U-phase upper arm switch SUH2, in the forward current decrease rate dif/dt of the U-phase lower arm diode DUL1 and the U-phase lower arm diode DUL2 when switched from the L level mode to the H-L dead time mode, in the forward voltage of the U-phase lower arm diode DUL1 and the U-phase lower arm diode DUL2, in the forward voltage of the U-phase lower arm diode DUL1 and the U-phase lower arm diode DUL2, and in the forward voltage of the U-phase lower arm diode DUL1 and the U-phase lower arm diode DUL2, an imbalance of the recovery currents flowing in each of the U-phase upper arm diode DUH1 and the U-phase upper arm diode DUH2 may occur. In the example shown in FIG. 6, the recovery current flowing in the U-phase first upper arm diodeUH1 is smaller than the recovery current flowing in the U-phase second upper arm diode UH2, and the first voltage ΔV1 is smaller than the second voltage ΔV2.

In this case, the gate voltage of the U-phase first upper arm switch SUH1, which is the smaller voltage of each switch SUH1 and SUH2, is higher than the gate voltage of the U-phase second upper arm switch SUH2, which is the greater (larger) voltage. As a result, the on-resistance of the U-phase first upper arm switch SUH1 is smaller than the on-resistance of the U-phase second upper arm switch SUH2. Then, as shown in FIG. 7, the recovery current flowing in the U-phase first upper arm diodeUH1 becomes greater (larger) than the recovery current flowing in the U-phase second upper arm diodeUH2, and the second voltage ΔV2 becomes smaller than the first voltage ΔV1.

In this case, the gate voltage of the U-phase second upper arm switch SUH2, which is the smaller voltage of each switch SUH1 and SUH2, is higher than the gate voltage of the U-phase first upper arm switch SUH1, which is the greater (larger) voltage. As a result, the on-resistance of U-phase second upper arm switch SUH2 becomes smaller than that of U-phase first upper arm switch SUH1. As a result, the recovery current flowing in the U-phase second upper arm diodeUH2 is greater (larger) than the recovery current flowing in the U-phase first upper arm diodeUH1.

Due to the repetition of such an event, the gate voltage of each switch SUH1 and SUH2 oscillates. When the gate voltage oscillates, the gate voltage may exceed the allowable upper limit of the gate voltage, resulting in the failure of the switches SUH1 and SUH2.

In this embodiment, the characteristic structure of the inverter 30 and the characteristic control of the inverter 30 suppress the occurrence of the gate voltage oscillation and the imbalance of the recovery currents.

A characteristic structure is, as mentioned above, in which the inductance of the first upper arm path and the second upper arm path are at similar levels, and the inductance of the first lower arm path and the second lower arm path are at similar levels.

The characteristic control is an oscillation suppression control, which is explained below. When the control device 50 determines that the magnitude of the phase current detected by current sensor 40 exceeds the threshold current Ith in each phase, the control device 50 performs the oscillation suppression control for the phase. On the other hand, when the control device 50 determines that the magnitude of the phase current is less than the threshold current Ith, the control device 50 performs a normal switching control for the inverter 30. The reason for performing the oscillation suppression control when the magnitude of the phase current exceeds the threshold current Ith is to limit oscillation suppression control to the situation where the degree of recovery currents imbalance is large and the gate voltage oscillation is likely to occur. The following is an example of a case in which the magnitude of the U-phase current among the U-phase, V, and W exceeds the threshold current Ith and oscillation suppression control is performed for the U-phase.

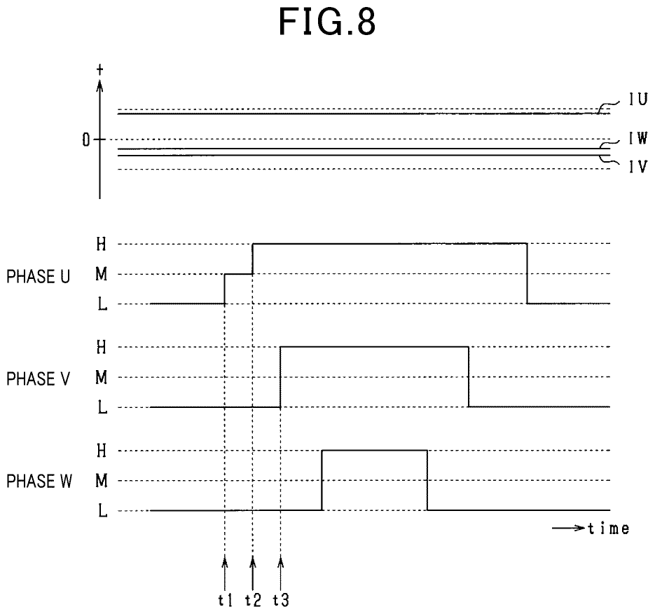

FIG. 8 shows a phase currents IU, a phase current IV, and a phase current IW flowing in the winding 11U, the winding 11V, and the winding 11W, and the switching modes of the U-phase, V, and W, respectively. For the phase currents IU, the phase current IV, and the phase current IW, the case where the current flows in the direction from inverter 30 to the winding is defined as positive.

As shown in FIG. 8, the control device 50 switches the switching mode from the L level mode to the M level mode at time t1 and from the M level mode to the H level mode at time t2. The control device 50 switches from the L level mode to H level mode. In this case, the control device 50 prohibits performing the H-L dead time mode and implements the M level mode during the switching.

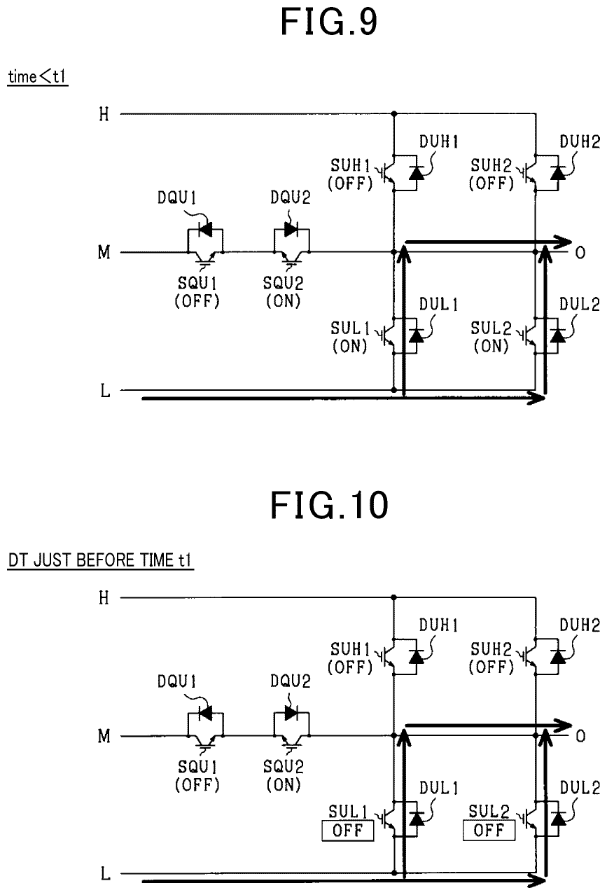

FIG. 9 shows the current distribution when the L level mode is performed before time t1. FIG. 10 shows the current distribution when the L level mode is switched to the M-L dead time mode from the L level mode just before time t1.

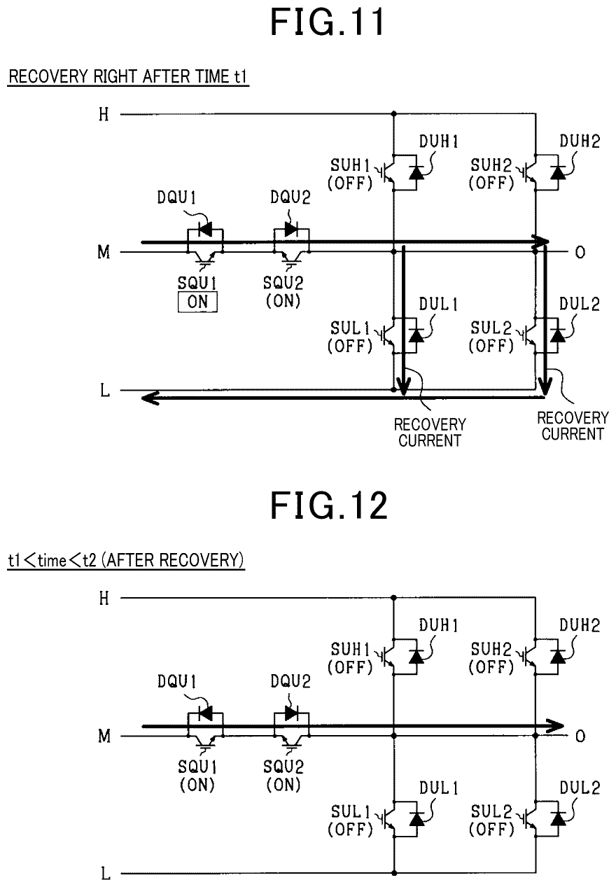

At time t1, the control device 50 switches from the M-L dead time mode to the M level mode. As shown in FIG. 11, this causes a reverse voltage to be applied to the U-phase first upper arm diode DUL1 and the U-phase second upper arm diode DUL2, after which a recovery current flows in the U-phase first upper arm diode DUL1 and the U-phase second upper arm diode DUL2. In this case, the recovery current flows only in the lower arm among the upper and lower arms. Therefore, the paths including the U-phase first upper arm diode DUH1, the U-phase second upper arm diode DUH2 and the high potential bus bar 72 is excluded from the distribution path of the recovery current. As a result, the factors that cause variations in the impedance of the two paths through which the recovery current flows is reduced, and the imbalance of the recovery currents is suppressed. This suppresses gate voltage oscillation.

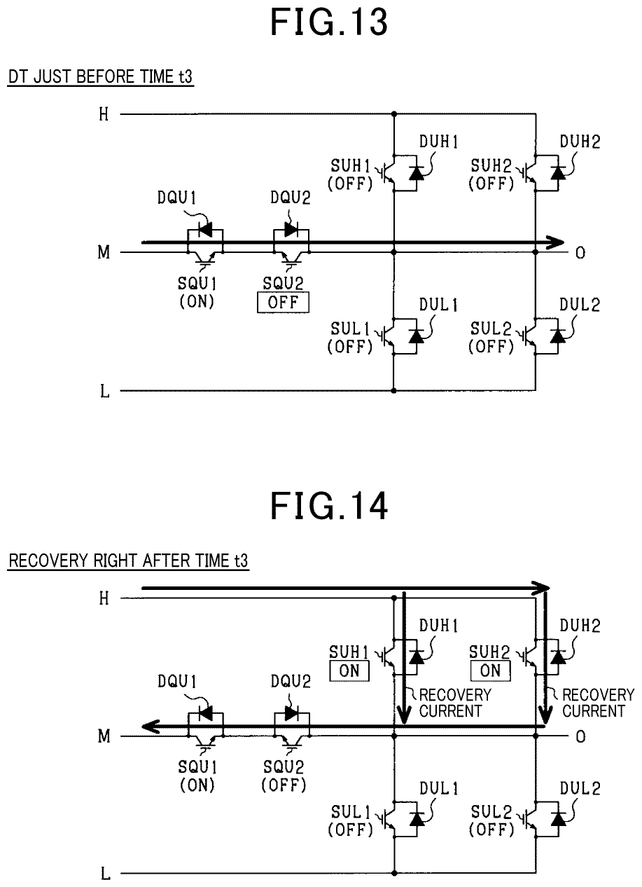

FIG. 12 shows the current distribution when the M level mode is executed before time t3. FIG. 13 shows the current flow pattern when the M level mode is switched to the H-M dead time mode just before time t3. It is desirable that the performance period of the H-M dead time mode is set to a longer period than the reverse recovery time of the upper and lower diodes DUH1, DUH2, DUL1, DUL2.

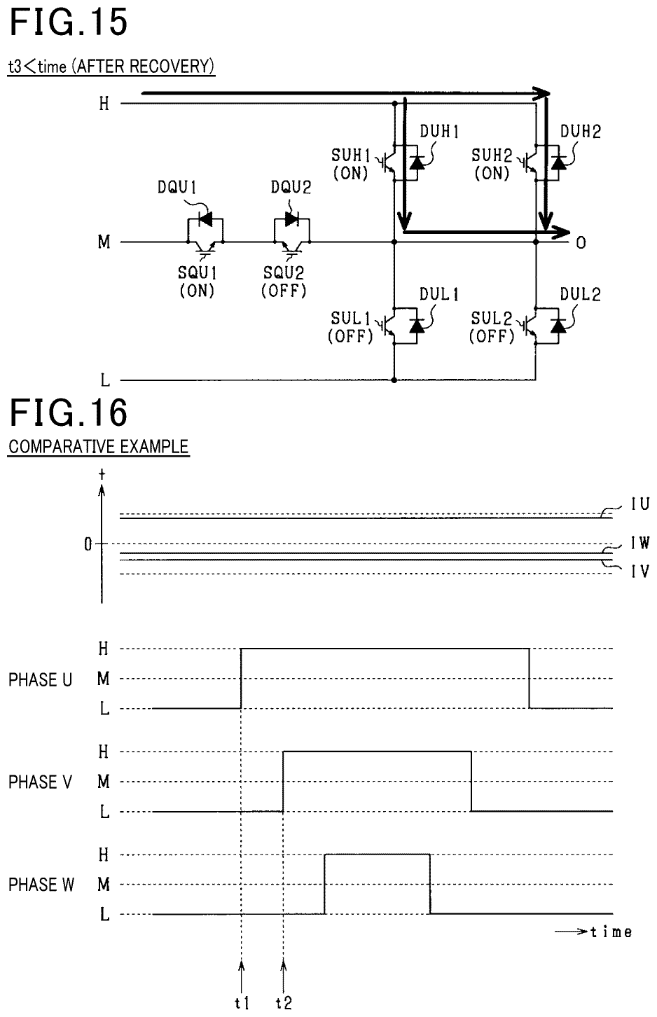

At time t3, the control device 50 switches the switching mode from the H-M dead time mode to the H level mode. As shown in FIG. 14, this causes a reverse voltage to be applied to the U-phase first upper arm diode DUH1 and the U-phase second upper arm diode DUH2, then a recovery current flows in the U-phase first upper arm diode DUH1 and the U-phase second upper arm diode DUH2. In this case, the recovery current flows only in the upper arm among the upper arm and lower arm. Therefore, the paths including the U-phase first upper arm diode DUL1, the U-phase second upper arm diode DUL2 and the low potential bus bar 71 is excluded from the distribution path of the recovery current. As a result, the factors that cause variations in the impedance of the two paths through which the recovery current flows are reduced, and the imbalance of the recovery currents is suppressed. As a result, the oscillation of the gate voltage is suppressed. FIG. 15 shows the current distribution paths after the recovery is completed immediately after time t3.

In contrast, according to the comparative example of control device that performs the H-L dead time mode when switching from the L level mode to the H level mode and does not perform the M level mode during the switching, the recovery current imbalance is greater than the case of this embodiment. The following explanation of the comparative example of the control device is given using FIGS. 16 to 20.

As shown in FIG. 16, the comparative example switches the switching mode from the L level mode to the H level mode for the U-phase at time t1 and switches the switching mode from the L level mode to the H level mode for the V-phase at time t2.

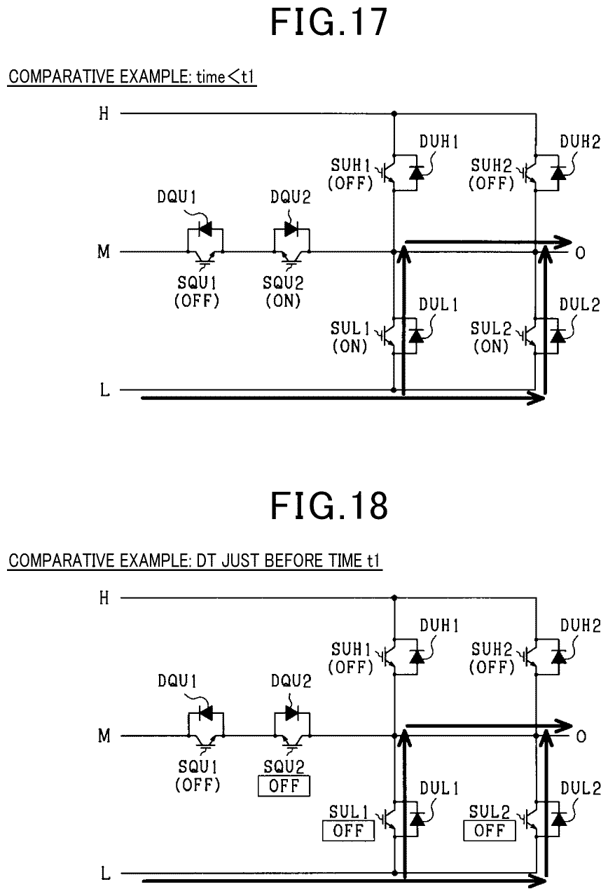

FIG. 17 shows the current distribution when the L level mode is performed before time t1. FIG. 18 shows the current distribution when the L level mode is switched to the H-L dead time mode just before time t1.

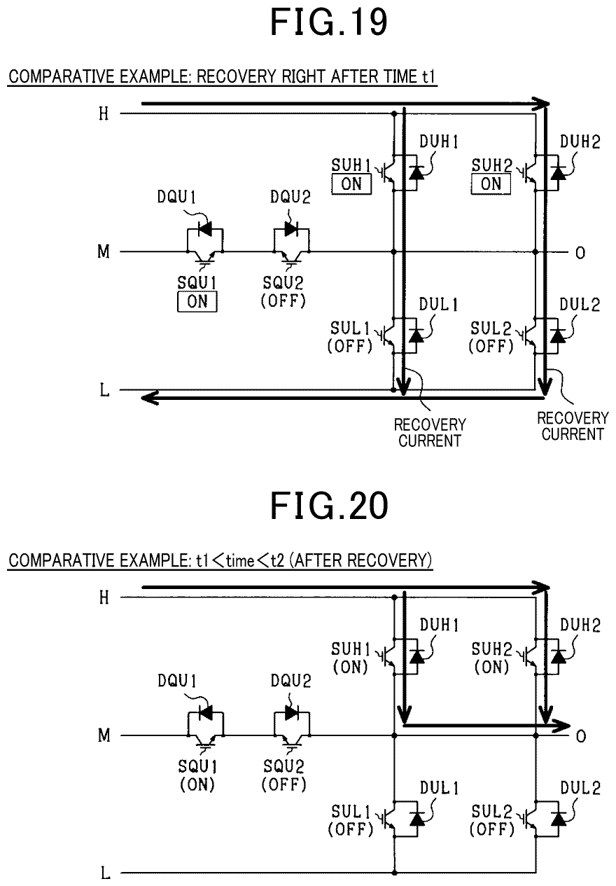

The comparative example switches the switching mode from the H-L dead time mode to the H level mode at time t1. As a result, as shown in FIG. 19, recovery currents flow in the U-phase first upper arm diode DUH1, the U-phase second upper arm diode DUH2, the U-phase first lower arm diode DUL1, and the U-phase second lower arm diode DUL2. In this case, the distribution paths of the recovery currents include the paths of both the upper and lower arms. As a result, the factor that causes impedance variations in the two paths through which the recovery current flows are not reduced. FIG. 20 shows the current distribution paths after the recovery is completed immediately after time t1.

FIG. 21 shows a flowchart of the switching control of the inverter 30 performed by the control device 50. This switching control is performed in each phase.

In step S10, the control device 50 determines whether the magnitude of the phase current detected by the current sensor 40 exceeds the threshold current Ith.

When the control device 50 obtains a negative determination result in step S10, the control device 50 proceeds to step S11 and performs the normal switching control of the inverter 30. On the other hand, when the control device 50 obtains a positive determination result in step S10, the control device 50 proceeds to step S12 and performs the oscillation suppression control described using FIGS. 8 to 15.

As explained above, the M level mode is implemented in the middle of switching from the L level mode to the H level mode. In detail, when switching from the L level mode to the H level mode, the control device 50 prohibits the execution of the H-L dead time mode and switches the switching mode from the L level mode to the H level mode via the M-L dead time mode, the M level mode, and the H-M dead time mode. This suppresses the imbalance of the recovery currents and the gate voltage oscillation.

### Second Embodiment

The second embodiment is described below with reference to the drawings, focusing on the differences from the first embodiment. In this embodiment, as shown in FIG. 22, the execution conditions for oscillation suppression control are changed. In detail, in step S13, whether the command torque Trq* exceeds the torque threshold Trqth is determined. When a positive determination result is obtained in step S13, the oscillation suppression control is performed by proceeding to step S12.

According to the second embodiment, when the command torque Trq* exceeds the torque threshold Trqth, oscillation suppression control is performed regardless of the magnitude of the phase current. This allows the same effect as in the first embodiment to be achieved.

### Third Embodiment

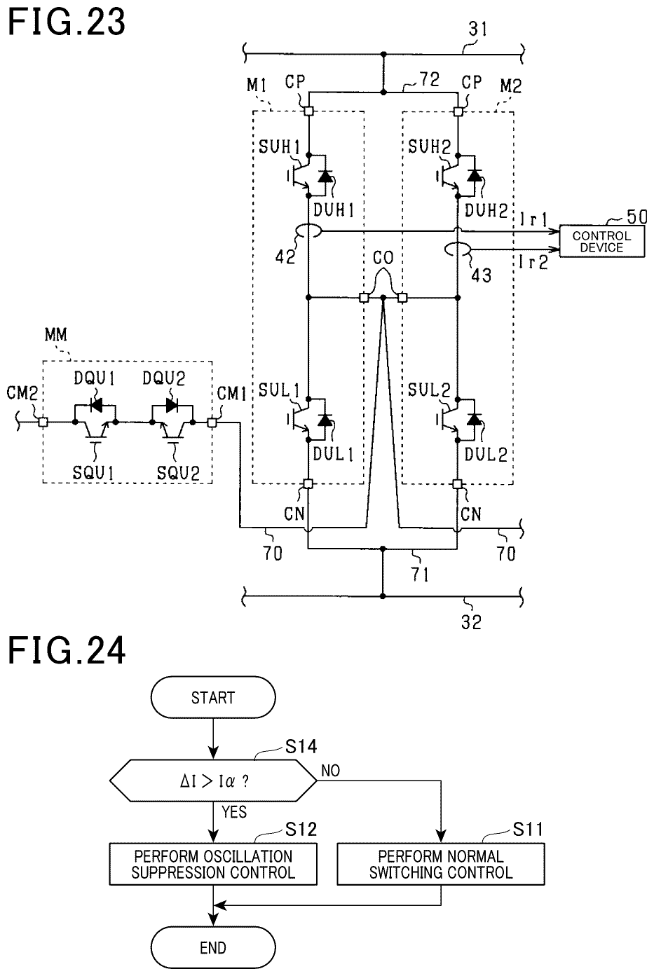

The third embodiment is described below with reference to the drawings, focusing on the differences from the first embodiment. In this embodiment, the control system includes individual current sensors that detect the collector current flowing in each switch. In FIG. 23, as an example of the individual current sensors, a first current sensor 42 that detects the collector current flowing to the U-phase first upper arm switch SUH1 and a second current sensor 43 that detects the collector current flowing to the U-phase second upper arm switch SUH2 are provided. The detected values of each current sensors 42 and 43 are input to the control device 50.

In the third embodiment, the performance condition of oscillation suppression control is changed as shown in FIG. 24. In detail, in step S14, the current difference ΔI, which is the difference between the collector current detected by the first current sensor 42 and the collector current detected by the second current sensor 43, is calculated. The controller 50 determines whether the calculated current difference ΔI exceeds the predetermined current difference Iα (e.g., 50 A). When a positive determination result is obtained in step S14, the control device 50 proceeds to step S12 and performs the oscillation suppression control.

For the U-phase first lower arm switch SUL1 and the U-phase second lower arm switch SUL2, individual current sensors should be provided and the process shown in FIG. 24 should be performed in the same manner as for the upper arm.

According to the third embodiment, the oscillation suppression control is performed by accurately identifying the situation in which the degree of recovery current imbalance becomes large.

### Another Embodiments

Each of the above embodiments may be modified as follows.

In the configuration shown in FIG. 23, one of the first and second current sensors 42 and 43 as individual current sensors may be provided at a position where the phase current flowing to the winding can be detected, for example, in the intermediate bus bar 70. In this case, the collector current flowing in the U-phase first upper arm switch SUH1 and the U-phase second upper arm switch SUH2, whichever is not provided with an individual current sensor, may be calculated based on the detected values of the first and second current sensors 42 and 43.

The position of the U-phase first switch SQU1 and the U-phase second switch SQU2 may be reversed; the same is true for the V and the W-phase middle switch.

The semiconductor switching devices that make up the inverter are not limited to IGBTs, but can be, for example, N-channel MOSFETs with body diodes. In this case, the high potential terminal of the semiconductor switching element is the drain and the low potential terminal is the source. In this case, the middle switch of each phase should consist of two N-channel MOSFETs connected to each other's source or each other's drain.

The three-level inverter may employ only one of them without employing both the characteristic structure that makes the impedance of each arm path at a similar level, and the characteristic control, that is the oscillation suppression control.

The number of parallel switch connections for each phase and each arm is not limited to two but may be three or more.

The motors are not limited to star-connected motors but can also be delta-connected motors.

The inverter, motor, and control device are not limited to being mounted to vehicles but can also be mounted to mobile objects such as aircraft or ships, for example. The destination of inverters, motors, and control devices is not limited to mobile vehicles.

The control unit and methods described in this disclosure may be realized by a dedicated computer provided by including a processor and memory programmed to perform one or more functions embodied in a computer program. Alternatively, the control section and methods described in this disclosure may be realized by a dedicated computer provided by configuring the processor with one or more dedicated hardware logic circuits. Alternatively, the control section and its methods described in this disclosure may be realized by one or more dedicated computers provided by a combination of a processor and memory programmed to perform one or more functions and a processor configured by one or more dedicated hardware logic circuits. The computer program may also be stored in a computer-readable non-transitory recording medium as instructions to be executed by a computer.

The following is a description of the characteristic configurations extracted from each of the above-mentioned embodiments.

### Configuration 1

A three-level inverter (30) including for each phase:
a plurality of series-connected elements connected in parallel with each other, each of the series-connected elements including:
an upper arm switch (SUH1 to SWH2) and a lower arm switch (SUL1 to SWL2) connected in series;
an upper arm diode (DUH1 to DWH2) connected in reverse parallel to the upper arm switch; and
a lower arm diode (DUL1 to DWL2) connected in reverse parallel to the lower arm switch;
wherein
the three-level inverter further includes:
a middle switch (SQU1-SQW2);
a high potential conductive member (72) that electrically connects the high potential terminal of each of the upper arm switches provided by the plurality of series-connected elements and a positive bus (31);
a low potential conductive member (71) that electrically connects the low-potential terminal of each of the lower arm switches provided by the plurality of series-connected elements and a negative bus (32); and
an intermediate conductive member (70) that electrically connects the low potential terminal of each of the upper arm switches provided by the plurality of series-connected elements, the high potential terminal of each of the lower arm switches provided by the plurality of series-connected elements, and the first end of the middle switch,
wherein,
the impedance of each of a plurality of upper arm paths is configured to be at a similar level, each of the plurality of upper arm paths being provided by a respective upper arm diode and providing an electrical path that connect a connection point (72c) of the high potential conductive member and the positive bus to the first end of the middle switch via the respective upper arm diode and the intermediate conductive member, and
the impedance of each of a plurality of lower arm paths is configured to be at a similar level, each of the plurality of lower arm paths being provided by a respective lower arm diode and providing an electrical paths that connect a connection point of the low potential conductive member and the negative bus to the middle switch via the lower arm diode and the intermediate conductive member.

### Configuration 2

The three-level inverter according to configuration 1,
further including a plurality of arm modules (M1, M2), each of the plurality of arm modules corresponding to the respective one of the plurality of the series-connected elements, and wherein
each of the arm modules includes the respective one of the series-connected elements and a first casing (60), and
the respective one of the series-connected elements is stored in the first casing as an integrated composition.

### Configuration 3

The three-level inverter according to configuration 2, wherein
the middle switch includes a first switch (SQU1), a first diode (DQU1) connected in reverse parallel to the first switch, a second switch (SQU2) connected in series with the first switch, and a second diode (DQU2) connected in reverse parallel to the second switch,
the three-level inverter further includes an intermediate module (MM),
the intermediate module includes the first switch, the first diode, the second switch, the second diode, and a second casing (60), and
the first switch, the first diode, the second switch, and the second diode are stored in the second casing as an integrated composition.

### Configuration 4

The three-level inverter according to configuration 3, wherein
the three-level inverter includes two series-connected elements as the plurality of series-connected elements for each phases,
shape of each of two first casings and the second casing is flat rectangular,
the two arm modules have the same specification,
the intermediate module is positioned between the two arm modules, the intermediate module and the two arm modules are arranged in a thick direction of the first casings and the second casing,
a terminal installation surface (62) of each of the two first casings and the second casing faces a common direction,
on each of the terminal installation surface of each of the two first casings, a high potential external terminal (CP) electrically connected to the high potential terminal of upper arm switch, a low potential external terminal (CN) electrically connected to the low potential terminal of the lower arm switch, and an intermediate external terminal (CO) electrically connected to the low potential terminal of the upper arm switch and the high potential terminal of the lower arm switch are installed,
on the terminal installation surface of the second casing, a neutral point terminal (CM2) electrically connected to the second switch is installed,
the intermediate external terminals and the neutral point terminal are arranged in a thick direction of the two first casings and the second casing,
the high potential external terminals are arranged in the thick direction,
the low potential external terminals are arranged in the thick direction,
the high potential conductive member electrically connects the two high potential external terminals,
the low potential conductive member electrically connects the two low potential external terminals,
the intermediate conductive member electrically connects the intermediate external terminals and the neutral point terminal, and
the shapes of each of the high potential conductive member, the low potential conductive member and the intermediate conductive member is symmetrical about a reference axis (BL) passing through the center of the thick direction of the second casing in a front view of the terminal installation surface of the second casing.

### Configuration 5

The three-level inverter according to any one of configurations 1 to 4, wherein
the middle switch includes a first switch (SQU1), a first diode (DQU1) connected in reverse parallel to the first switch, a second switch (SQU2) connected in series with the first switch, and a second diode (DQU2) connected in reverse parallel to the second switch,
the three-level inverter further includes a control device (50) that switches switching modes between a H level mode, a M level mode and a L level mode, and performs oscillation suppression control to implement the M level mode in the middle of switching from the L level mode to the H level mode,
the H level mode is a switching mode in which the upper arm switch is turned on and the lower arm switch is turned off to output a H level voltage,
the M level mode is a switching mode in which the first switch and the second switch are turned on and the upper arm switch and the lower arm switch are turned off to output M level voltage, and
the L level mode is a switching mode in which the lower arm switch is turned on and the upper arm switch is turned off to output a L level voltage.

### Configuration 6

The three-level inverter according to configuration 5, wherein
the oscillation suppression control includes prohibiting a H-L dead time mode, that is a switching mode in which the upper arm switch, the lower arm switch, the first switch, and the second switch are turned off, and switching the switching mode from the L level mode to the H level mode via the M level mode and the H-M dead time mode,
the H-M dead time mode is a switching mode in which the upper arm switch, the lower arm switch, and the second switch are turned off and the first switch is turned on,
the performance period of the H-M dead time mode is set to a longer period than the reverse recovery time of the upper arm diode and the lower arm diode.

### Configuration 7

The three-level inverter according to configuration 5, wherein
the control device performs the oscillation suppression control when specified conditions are met, and
the specific conditions are one of:
the magnitude of the output current of the three-level inverter exceeds the threshold current (Ith);
the magnitude of the commanded torque of the motor electrically connected to the three-level inverter exceeds the torque threshold (Trqth);
the difference in the magnitude of the current flowing between the high potential terminal and the low potential terminal of each of the upper arm switch connected in parallel exceeds the specified current difference (Iα);
the difference in the magnitude of the current flowing between the high potential terminal and the low potential terminal of each of the lower arm switch connected in parallel exceeds a predetermined current difference (Iα).

### Configuration 8

The three-level inverter according to any one of configurations 1 to 4, further including for each phase:
a first capacitor (21) that electrically connects the second end of the middle switch and the positive bus; and
a second capacitor (22) that electrically connects the second end of middle switch and the negative bus.

### Configuration 9

A three-level inverter (30) including for each phase:
a plurality of series-connected elements connected in parallel with each other, each of the series-connected elements including:
an upper arm switch (SUH1 to SWH2) and a lower arm switch (SUL1 to SWL2) connected in series;
an upper arm diode (DUH1 to DWH2) connected in reverse parallel to the upper arm switch; and
a lower arm diode (DUL1 to DWL2) connected in reverse parallel to the lower arm switch;
wherein
the three-level inverter further includes:
a middle switch (SQU1-SQW2);
a high potential conductive member (72) that electrically connects the high potential terminal of each of the upper arm switches provided by the plurality of series-connected elements and a positive bus (31);
a low potential conductive member (71) that electrically connects the low-potential terminal of each of the lower arm switches provided by the plurality of series-connected elements and a negative bus (32);
an intermediate conductive member (70) that electrically connects the low potential terminal of each of the upper arm switches provided by the plurality of series-connected elements, the high potential terminal of each of the lower arm switches provided by the plurality of series-connected elements, and the first end of the middle switch; and
a control device (50),
wherein the middle switch includes a first switch (SQU1), a first diode (DQU1) connected in reverse parallel to the first switch, a second switch (SQU2) connected in series with the first switch, and a second diode (DQU2) connected in reverse parallel to the second switch, and
the control device switches switching modes between a H level mode, a M level mode and a L level mode, and performs oscillation suppression control to implement the M level mode in the middle of switching from the L level mode to the H level mode,
the H level mode is a switching mode in which the upper arm switch is turned on and the lower arm switch is turned off to output a H level voltage,
the M level mode is a switching mode in which the first switch and the second switch are turned on and the upper arm switch and the lower arm switch are turned off to output M level voltage, and
the L level mode is a switching mode in which the lower arm switch is turned on and the upper arm switch is turned off to output a L level voltage.

### Configuration 10

A program applied to a three-level inverter (30) including for each phase:
a plurality of series-connected elements connected in parallel with each other, each of the series-connected elements including:
an upper arm switch (SUH1 to SWH2) and a lower arm switch (SUL1 to SWL2) connected in series;
an upper arm diode (DUH1 to DWH2) connected in reverse parallel to the upper arm switch; and
a lower arm diode (DUL1 to DWL2) connected in reverse parallel to the lower arm switch;
wherein
the three-level inverter further includes:
a middle switch (SQU1-SQW2);
a high potential conductive member (72) that electrically connects the high potential terminal of each of the upper arm switches provided by the plurality of series-connected elements and a positive bus (31);
a low potential conductive member (71) that electrically connects the low-potential terminal of each of the lower arm switches provided by the plurality of series-connected elements and a negative bus (32);
an intermediate conductive member (70) that electrically connects the low potential terminal of each of the upper arm switches provided by the plurality of series-connected elements, the high potential terminal of each of the lower arm switches provided by the plurality of series-connected elements, and the first end of the middle switch; and
a control device (50),
wherein the middle switch includes a first switch (SQU1), a first diode (DQU1) connected in reverse parallel to the first switch, a second switch (SQU2) connected in series with the first switch, and a second diode (DQU2) connected in reverse parallel to the second switch, and
the program causes the control device to switch switching modes between a H level mode, a M level mode and a L level mode, and perform oscillation suppression control to implement the M level mode in the middle of switching from the L level mode to the H level mode,
the H level mode is a switching mode in which the upper arm switch is turned on and the lower arm switch is turned off to output a H level voltage,
the M level mode is a switching mode in which the first switch and the second switch are turned on and the upper arm switch and the lower arm switch are turned off to output M level voltage, and
the L level mode is a switching mode in which the lower arm switch is turned on and the upper arm switch is turned off to output a L level voltage.

Although this disclosure has been described in accordance with examples, it is understood that this disclosure is not limited to said examples or structures. The present disclosure also encompasses various variations and transformations within the scope of equality. In addition, various combinations and forms, as well as other combinations and forms including only one element, thereof, also fall within the scope and idea of this disclosure.

What is claimed is:

1. A three-level inverter comprising for each phase:
a plurality of series-connected elements connected in parallel with each other, each of the series-connected elements including:
an upper arm switch and a lower arm switch connected in series;
an upper arm diode connected in reverse parallel to the upper arm switch; and
a lower arm diode connected in reverse parallel to the lower arm switch;
wherein
the three-level inverter further comprises:
a middle switch;
a high potential conductive member that electrically connects the high potential terminal of each of the upper arm switches provided by the plurality of series-connected elements and a positive bus;
a low potential conductive member that electrically connects the low-potential terminal of each of the lower arm switches provided by the plurality of series-connected elements and a negative bus; and
an intermediate conductive member that electrically connects the low potential terminal of each of the upper arm switches provided by the plurality of series-connected elements, the high potential terminal of each of the lower arm switches provided by the plurality of series-connected elements, and the first end of the middle switch,
wherein,
the impedance of each of a plurality of upper arm paths is configured to be at a similar level, each of the plurality of upper arm paths being provided by a respective upper arm diode and providing an electrical path that connect a connection point of the high potential conductive member and the positive bus to the first end of the middle switch via the respective upper arm diode and the intermediate conductive member, and
the impedance of each of a plurality of lower arm paths is configured to be at a similar level, each of the plurality of lower arm paths being provided by a respective lower arm diode and providing an electrical paths that connect a connection point of the low potential conductive member and the negative bus to the middle switch via the lower arm diode and the intermediate conductive member.

2. The three-level inverter according to claim 1,
further comprising a plurality of arm modules, each of the plurality of arm modules corresponding to the respective one of the plurality of the series-connected elements, and wherein
each of the arm modules includes the respective one of the series-connected elements and a first casing, and
the respective one of the series-connected elements is stored in the first casing as an integrated composition.

3. The three-level inverter according to claim 2, wherein
the middle switch includes a first switch, a first diode connected in reverse parallel to the first switch, a second switch connected in series with the first switch, and a second diode connected in reverse parallel to the second switch,
the three-level inverter further comprises an intermediate module,
the intermediate module includes the first switch, the first diode, the second switch, the second diode, and a second casing, and
the first switch, the first diode, the second switch, and the second diode are stored in the second casing as an integrated composition.

4. The three-level inverter according to claim 3, wherein
the three-level inverter comprises two series-connected elements as the plurality of series-connected elements for each phases,
shape of each of two first casings and the second casing is flat rectangular,
the two arm modules have the same specification,
the intermediate module is positioned between the two arm modules, the intermediate module and the two arm modules are arranged in a thick direction of the first casings and the second casing,
a terminal installation surface of each of the two first casings and the second casing faces a common direction,
on each of the terminal installation surface of each of the two first casings, a high potential external terminal electrically connected to the high potential terminal of upper arm switch, a low potential external terminal electrically connected to the low potential terminal of the lower arm switch, and an intermediate external terminal electrically connected to the low potential terminal of the upper arm switch and the high potential terminal of the lower arm switch are installed,
on the terminal installation surface of the second casing, a neutral point terminal electrically connected to the second switch is installed,
the intermediate external terminals and the neutral point terminal are arranged in a thick direction of the two first casings and the second casing,
the high potential external terminals are arranged in the thick direction,
the low potential external terminals are arranged in the thick direction,
the high potential conductive member electrically connects the two high potential external terminals,
the low potential conductive member electrically connects the two low potential external terminals,
the intermediate conductive member electrically connects the intermediate external terminals and the neutral point terminal, and
the shapes of each of the high potential conductive member, the low potential conductive member and the intermediate conductive member is symmetrical about a reference axis passing through the center of the thick direction of the second casing in a front view of the terminal installation surface of the second casing.

5. The three-level inverter according to claim 1, wherein
the middle switch includes a first switch, a first diode connected in reverse parallel to the first switch, a second switch connected in series with the first switch, and a second diode connected in reverse parallel to the second switch,
the three-level inverter further comprises a control device that switches switching modes between a H level mode, a M level mode and a L level mode, and performs oscillation suppression control to implement the M level mode in the middle of switching from the L level mode to the H level mode,
the H level mode is a switching mode in which the upper arm switch is turned on and the lower arm switch is turned off to output a H level voltage,
the M level mode is a switching mode in which the first switch and the second switch are turned on and the upper arm switch and the lower arm switch are turned off to output M level voltage, and
the L level mode is a switching mode in which the lower arm switch is turned on and the upper arm switch is turned off to output a L level voltage.

6. The three-level inverter according to claim 5, wherein
the oscillation suppression control includes prohibiting a H-L dead time mode, that is a switching mode in which the upper arm switch, the lower arm switch, the first switch, and the second switch are turned off, and switching the switching mode from the L level mode to the H level mode via the M level mode and the H-M dead time mode,
the H-M dead time mode is a switching mode in which the upper arm switch, the lower arm switch, and the second switch are turned off and the first switch is turned on,
the performance period of the H-M dead time mode is set to a longer period than the reverse recovery time of the upper arm diode and the lower arm diode.

7. The three-level inverter according to claim 5, wherein
the control device performs the oscillation suppression control when specified conditions are met, and
the specific conditions are one of:
the magnitude of the output current of the three-level inverter exceeds the threshold current;
the magnitude of the commanded torque of the motor electrically connected to the three-level inverter exceeds the torque threshold;
the difference in the magnitude of the current flowing between the high potential terminal and the low potential terminal of each of the upper arm switch connected in parallel exceeds the specified current difference;
the difference in the magnitude of the current flowing between the high potential terminal and the low potential terminal of each of the lower arm switch connected in parallel exceeds a predetermined current difference.

8. The three-level inverter according to claim 1, further comprising for each phase:
a first capacitor that electrically connects the second end of the middle switch and the positive bus; and
a second capacitor that electrically connects the second end of middle switch and the negative bus.

9. three-level inverter comprising for each phase:
a plurality of series-connected elements connected in parallel with each other, each of the series-connected elements including:
an upper arm switch and a lower arm switch connected in series;
an upper arm diode connected in reverse parallel to the upper arm switch; and
a lower arm diode connected in reverse parallel to the lower arm switch;
wherein
the three-level inverter further comprises:
a middle switch;
a high potential conductive member that electrically connects the high potential terminal of each of the upper arm switches provided by the plurality of series-connected elements and a positive bus;
a low potential conductive member that electrically connects the low-potential terminal of each of the lower arm switches provided by the plurality of series-connected elements and a negative bus;
an intermediate conductive member that electrically connects the low potential terminal of each of the upper arm switches provided by the plurality of series-connected elements, the high potential terminal of each of the lower arm switches provided by the plurality of series-connected elements, and the first end of the middle switch; and
a control device,
wherein the middle switch includes a first switch, a first diode connected in reverse parallel to the first switch, a second switch connected in series with the first switch, and a second diode connected in reverse parallel to the second switch, and
the control device switches switching modes between a H level mode, a M level mode and a L level mode, and performs oscillation suppression control to implement the M level mode in the middle of switching from the L level mode to the H level mode,
the H level mode is a switching mode in which the upper arm switch is turned on and the lower arm switch is turned off to output a H level voltage,
the M level mode is a switching mode in which the first switch and the second switch are turned on and the upper arm switch and the lower arm switch are turned off to output M level voltage, and
the L level mode is a switching mode in which the lower arm switch is turned on and the upper arm switch is turned off to output a L level voltage.

10. A non-transitory computer-readable storage medium storing a program applied to a three-level inverter comprising for each phase:
a plurality of series-connected elements connected in parallel with each other, each of the series-connected elements including:
an upper arm switch and a lower arm switch connected in series;
an upper arm diode connected in reverse parallel to the upper arm switch; and
a lower arm diode connected in reverse parallel to the lower arm switch;
wherein
the three-level inverter further comprises:
a middle switch;
a high potential conductive member that electrically connects the high potential terminal of each of the upper arm switches provided by the plurality of series-connected elements and a positive bus;
a low potential conductive member that electrically connects the low-potential terminal of each of the lower arm switches provided by the plurality of series-connected elements and a negative bus;
an intermediate conductive member that electrically connects the low potential terminal of each of the upper arm switches provided by the plurality of series-connected elements, the high potential terminal of each of the lower arm switches provided by the plurality of series-connected elements, and the first end of the middle switch; and
a control device,
wherein the middle switch includes a first switch, a first diode connected in reverse parallel to the first switch, a second switch connected in series with the first switch, and a second diode connected in reverse parallel to the second switch, and
the program causes the control device to switch switching modes between a H level mode, a M level mode and a L level mode, and perform oscillation suppression control to implement the M level mode in the middle of switching from the L level mode to the H level mode,
the H level mode is a switching mode in which the upper arm switch is turned on and the lower arm switch is turned off to output a H level voltage,
the M level mode is a switching mode in which the first switch and the second switch are turned on and the upper arm switch and the lower arm switch are turned off to output M level voltage, and
the L level mode is a switching mode in which the lower arm switch is turned on and the upper arm switch is turned off to output a L level voltage.
